(19) United States
(12) Patent Application Publication
(10) Pub. No.: US 2007/0106014 A1
(43) Pub. Date: May 10, 2007

(54) Method for producing composition containing polymer from liquid containing polymer component and drying apparatus for same

(76) Inventors: Daisuke Kanenari, Kanagawa (JP); Yoshiaki Kirino, Kanagawa (JP)

Correspondence Address: CONNOLLY BOVE LODGE & HUTZ LLP, P.O. BOX 2207, WILMINGTON, DE, 19899-2207, US

(21) Appl. No.: 10/582,238

(22) PCT Filed: Mar. 3, 2005
(86) PCT No.: PCT/JP05/04161

§ 371 Date: Jun. 9, 2006

(30) Foreign Application Priority Data
Apr. 12, 2004 (JP) 2004-116665
Dec. 9, 2004 (JP) 2004-356690

(51) Int. Cl. C08L 7/00

(52) U.S. Cl. 524/575.5; 524/430; 524/322; 524/425; 524/445; 524/493; 524/567

(57) ABSTRACT

By spraying and drying a liquid containing a polymer component (e.g., natural rubber, synthetic rubber, etc.) and a liquid containing a filler (e.g., carbon black, silica, etc.) under an atmosphere of a shock wave generated from pulse combustion, a polymer containing a filler is produced at an improved work efficiency and heat efficiency, without causing degradation of the quality, etc. of the product.

### TECHNICAL FIELD

The present invention relates to a method for producing a polymer composition containing a filler from a liquid containing a polymer component (e.g., a natural rubber, synthetic rubber, etc.) and a liquid containing a filler (e.g., carbon black, silica, etc.) at a good productivity and heat efficiency, without causing degradation of the quality of the polymer component and to a rubber/filler masterbatch obtained therefrom.

### BACKGROUND ART

A method for mixing a latex or organic solution of a rubber and a filler in the liquid states and removing the solvent therefrom to obtain a master batch or rubber composition is known (for example, see JP-A-1-198645 (Kokai), JP-A-2000-239397 (Kokai), and JP-A-2003-321551 (Kokai). In particular, when dispersing water glass, colloidal silica, clay, etc. in a polymer, the polymer and filler is dispersed in water or an organic solvent, then the solvent is removed, but this method requires a long time and there are the unavoidable phenomena that an organic solvent has to be used, variation in quality occurs due to the amount of solvent at the surface parts and inside, and the filler causes agglomeration. Further, JP-A-2000-239397 etc. propose a method for charging a composition containing a solvent into a high temperature and high shear mixer and vaporizing and removing the moisture while mixing. Also in this case, there was the defect that exposure to a high temperature is liable to cause a decrease in the physical properties of the polymer and molecular cleavage due to the high shear.

As conventional methods for producing a rubber/colloidal silica master batch, for example, the freeze drying method (i.e., (1) freezing, (2) thawing and coagulation, and (3) drying, of latex/colloidal silica), the alcohol coagulation method (i.e., (1) charging of latex/colloidal silica into an alcohol for coagulation and (2) cleaning and drying), etc. are known, but the former has the problem of a long freezing and thawing time or drying time, poor dispersion of silica, etc., whereas the latter has the problem that it requires the use of a large amount of an alcohol, has a long drying time, and does not allow blending of solvent-soluble components.

Further, Japanese Unexamined Patent Publication (Kokai) No. 2004-66204 discloses technology for mixing a filler and polymer latex and applying an ultrasonic wave to the mixture thus obtained to separate the clump-like substances of filler and polymer, but even with this method, while it becomes easier to separate the solvent (e.g. water) from the rubber and remove the solvent, it becomes impossible to completely remove the moisture until after a step of drying upon heat. A large number of problems remain in terms of the processing time and heat history.

At present, natural rubber (NR) is obtained by tapping sap from rubber trees by hand, filtering it, then coagulating and pressing the latex and shipping the resultant products out as sheets (i.e., RSS) or blocks (i.e., TSR). In this way, even at present, where the importance of natural rubber is conversely increasing, manual labor is still relied on to produce NR from rubber latex. Further, the process of the latex coagulation step, the rinsing step, and the drying step, in particular the drying step, has a great effect on the final viscosity of the resultant rubber, etc. From the viewpoint of the variation in rubber quality, the current method for producing rubber from rubber latex cannot be said to be sufficient. From this viewpoint, JP-A-2003-26704 (Kokai) proposes a method of production enabling an improvement of the productivity and quality. Further, a carbon black master batch of natural rubber (NR) is difficult to mix in the slurry state due to the instability of the latex. JP-A-2000-507892 discloses a method of simultaneously spraying and solidifying an NR latex and carbon black slurry and removing water, while mixing to produce an NR master batch. However, although this method features a good dispersability of carbon black for mixing at a high temperature as a drying step, problems remain in the physical properties of the rubber due to the heat history.

### DISCLOSURE OF INVENTION

Accordingly, the object of the present invention is to provide a method for producing a polymer composition containing a liquid containing a polymer component, for example, a polymer latex, in particular a natural rubber latex or a synthetic rubber latex obtained by emulsion polymerization, or other conventional polymers latex and containing a filler (e.g., carbon black, silica, etc.), wherein the work efficiency or heat efficiency is greatly improved and the heat degradation or gelling of the polymer (e.g., natural rubber or synthetic rubber) liable to occur in conventional drying by heating is suppressed so as to produce a superior quality polymer composition containing a filler (e.g., a natural rubber/carbon black master batch).

In accordance with the first aspect of the present invention, there is provided a method for producing a polymer composition containing a filler comprising simultaneously spraying and drying a liquid containing a polymer component and a liquid containing a filler under an atmosphere of a shock wave generated from pulse combustion and a polymer composition containing a filler obtained therefrom.

In accordance with to the first aspect of the present invention, there is provided a method for producing a polymer composition further comprising mixing the filler or the filler-containing liquid with a liquid containing said polymer component before spraying, followed by spraying.

According to the first aspect of the present invention, since, instead of the conventional processes of coagulation by acid etc., natural coagulation, etc., pulse combustion is used to cause the liquid including a polymer (e.g., natural rubber or synthetic rubber), for example, a polymer latex, to instantaneously dry, a great improvement in the productivity and heat efficiency is achieved. Further, since heat degradation or gelling of the polymer causing due to conventional drying upon heating is suppressed, the control of the polymer quality becomes far easier. Further, since gelling is suppressed, the viscosity of the polymer decreases and the mastication step of the rubber and other later processing of the polymer can be simplified, when compared with the past.

In accordance with the second aspect of the present invention, there is provided a method for producing a natural rubber/carbon black master batch comprising mixing, into a natural rubber latex, an aqueous slurry of carbon black containing 1 to 200 parts by weight of carbon black based upon 100 parts by weight, in terms of a solid, of the rubber and 1 to 30 wt % of a surfactant, based upon the weight of the carbon black, then spraying and drying the mixture under an atmosphere of a shock wave derived from pulse combustion.

In accordance with the second aspect of the present invention, there is also provided a method for producing a natural rubber/carbon black master batch comprising mixing, into a natural rubber latex, an aqueous slurry of carbon black and a water-soluble polymer, then spraying and drying the mixture thus obtained under an atmosphere of a shock wave generated from pulse combustion.

In accordance with the second aspect of the present invention, there is further provided an apparatus for mixing and drying a solution or dispersion of at least two solid substances, of which drying apparatus is provided with pumps for feeding at least two starting liquids, a control mechanism for controlling a feed ratio of the pumps, at least two starting liquid feed lines for feeding at least two starting liquids at any ratio and a pulse combuster for spraying said two starting liquids after combining into a single feed line, and then drying the mixture under an atmosphere of a shock wave generated from pulse combustion.

According to the second aspect of the present invention, since, instead of the conventional processes of coagulation by acid etc., natural coagulation, etc., pulse combustion is used to cause a slurry liquid containing a natural rubber and carbon black to instantaneously dry, a great improvement in the productivity and heat efficiency is achieved. Further, since heat degradation of the natural rubber or gelling of the natural rubber arising due to conventional drying upon heating is suppressed, the control of the quality of the master batch becomes far easier. Further, since gelling is suppressed, the viscosity of the natural rubber decreases and the mastication step of the rubber and other later processing of the rubber can be simplified compared with the past.

### BRIEF DESCRIPTION OF DRAWINGS

The present invention will now be explained in detail, while referring to the attached drawings, wherein:

FIG. 1 is an explanatory view of an example of a pulse combustion drying apparatus of the present invention;

FIG. 2 a view of an example of the structure of a spraying unit of a conventional pulse combustion drying apparatus;

FIG. 3 is a view of an example of the structure of a spraying unit of a pulse combustion drying apparatus of the present invention; and

FIG. 4 is a view of another example of the structure of a spraying unit of a pulse combustion drying apparatus of the present invention.

### BEST MODE FOR CARRYING OUT THE INVENTION

In the description and claims of this application, the singular forms “a”, “an” and “the” include plural forms insofar as it is not clear from the context that the form is singular.

The inventors found that, by mixing a liquid including a polymer component, for example, a liquid including a natural rubber, a synthetic rubber, or another latex, and a filler and spraying the slurry-like, sol-like or aqueous solution liquid (that is, slurry, sol, or solution, the same below) under an atmosphere of a shock wave generated from pulse combustion to remove the solvent (i.e., water or organic solvent) and dry the liquid instantaneously, it is possible to produce a polymer of a master batch, etc. in a short time and low cost, without accompanying degradation or gelling of the polymer.

Note that the method of spraying a liquid containing a polymer component and a slurry, sol, or solution of a filler under an atmosphere of a shock wave generated from pulse combustion is not particularly limited, but for example it is also possible to simultaneously spray a liquid containing a polymer and slurry, sol, or solution of a filler from separate nozzles or separately feed them and combine them by a constant ratio just before spraying, then spray the result from a single nozzle or to mix the polymer latex and slurry, sol, or solution of the filler in advance and feed and spray the mixture from a nozzle.

As the filler, for example, carbon black, silica, colloidal silica, water-glass, clay, calcium carbonate, clay, etc. is preferably used. The viscosity of the mixture before drying processed in this way is preferably 3000 mPa·s or less, more preferably 2000 mPa·s or less, particularly preferably 1000 mPa·s or less. Due to this, it is possible to effectively prevent clogging of the feed pipes, poor drying, etc. Note that the “viscosity” herein means the viscosity as measured by a type B viscometer.

In this way, according to the method of the present invention, the drying of the wet master batch or other polymer mixture containing the filler, which used to take an extremely long time, becomes instantaneous, and therefore, it becomes possible to produce the rubber/filler master batch by an industrially sufficient processing capability.

Further, by mixing a vulcanizing agent or other rubber additive(s) generally blended into an aqueous or organic solution of a rubber composition and drying the mixture by the method of the present invention, it is possible to greatly reduce the steps of blending compounding agents into the rubber which had been conventionally performed by a Banbury mixer, kneader, etc. and immediately feed the compound into the extrusion, rolling, or other step through a simple mixing step aimed at dispersion.

According to the present invention, as explained above, for example, a filler is mixed with a natural rubber latex, a synthetic rubber latex synthesized by emulsion polymerization, or a latex, sol, or solution of a polymer produced by cationic polymerization, nonionic polymerization, radical polymerization, etc. This mixture was dried using a pulse combuster for generating a pulse shock wave described in, for example, JP-A-6-28681 (Kokai) to produce a polymer composition. In the present invention, by using such a pulse combustion apparatus to spray dry a polymer mixture with a solid concentration of 60 wt % or less at preferably a frequency of 50 to 1200Hz, more preferably 250 to 1000 Hz, preferably at a temperature of 140° C. or less, more preferably 40 to 100° C., in a drying chamber, it is possible to obtain a polymer composition.

As the solution including a polymer component which can be dried by the present invention, natural rubber latices, various types of polybutadiene rubbers (BR), various types of styrene-butadiene copolymer rubbers (SBR) and other emulsion polymerized latices, solution polymerized rubber solutions, and water-soluble polymers (e.g., starch, polysaccharides, proteins, cellulose ethers, polyvinyl alcohol) and other polymer slurries, sols or solutions may be mentioned.

The solid concentration of the polymer mixture for drying according to the present invention is not particularly limited, but 60 wt % or less is preferable, while 20 to 50 wt % is more preferable. If the solid concentration is more than 60 wt %, the viscosity of the polymer mixture becomes too high and simultaneously the stability of the polymer in a mixture decreases, and therefore, when charging the mixture into a pulse shock wave dryer, the mixture will coagulate inside the feed pipes, the mixture cannot be sprayed well into the drying chamber, or other problems are liable to arise. Further, when the solid concentration is too low, there is no problem in the drying itself, but the amount of the polymer mixture which can be dried per unit time is decreased and therefore there is liable to be a problem in drying efficiency.

For the method of drying a polymer composition including a filler according to the present invention, it is possible to mix, into the polymer composition, in advance, other compounding agents (for example, an antioxidant, various types of carbon blacks, various types of silicas, other fillers, oils, plasticizers, cross-linking agents, vulcanization accelerators, vulcanization accelerating aids, peptisers, coloring agents, coupling agents, preservatives, resins, or emulsifiers) or other third ingredients in an aqueous solution, aqueous dispersion, and/or hydrophilic organic solvent solution into one or both of the solution including the polymer and the solution containing the filler and drying the mixture to obtain a polymer composition containing these blended ingredients. Further, it is possible to mix, in advance, two or more types of solutions containing polymer ingredients at a predetermined ratio and directly obtain a blend of different types of polymers.

According to the second aspect of the present invention, it is possible to dry a latex including a natural rubber as a polymer ingredient and an aqueous slurry including carbon black, as a filler, using a pulse combustion apparatus generating a pulse shock wave as described in, for example, JP-B-6-28681 (Kokoku) so as to produce a natural rubber/carbon black master batch. In the present invention, it is possible to achieve the above object by using the pulse combuster to preferably spray dry a natural rubber (NR) latex having a solid concentration of 60 wt % or less and an aqueous slurry of carbon black (CB) having a concentration of 20 wt % or less at a ratio of NR/CB (solid weight ratio)=100/1 to 100/200, preferably at a frequency of 50 to 1200 Hz, more preferably 200 to 1000 Hz, preferably at a temperature of 140° C. or less, more preferably 40 to 100° C., in a dryer.

The solid concentration of the mixture of the natural rubber latex and carbon black slurry dried according to the second aspect of the present invention is preferably 60 wt % or less, more preferably 10 to 50 wt %. If this solid concentration is too high, the viscosity of the natural rubber latex will become high and simultaneously the stability will decrease, and therefore when charged into the pulse shock wave dryer, the mixture will solidify in the feed pipes, the mixture will not be sprayed well into the drying chamber, or other problems may occur. Further, if the solid concentration is too low, while there will not be any problem in the drying itself, the amount capable of being dried in unit time will be decreased, and therefore this will not be practical.

The inventors found that, by mixing a natural rubber latex and an aqueous slurry of carbon black to obtain a slurry state or sol state and spraying the mixture in an atmosphere of a shock wave generated from pulse combustion to remove the solvent (e.g., water or organic solvent) and dry the mixture instantaneously, it is possible to produce a master batch in a short time and a low cost, without degradation or gelling of the polymer. Note that the method for spraying the natural rubber latex and aqueous slurry of carbon black in an atmosphere of a shock wave generated from pulse combustion is not particularly limited, but, for example, it is also possible to simultaneously spray the natural rubber latex and carbon black slurry from separate nozzles, to separately feed them and combine them at a certain ratio just before spraying, and then spray the mixture from a single nozzle, or mix the natural rubber latex and aqueous slurry of carbon black, in advance, and feed them together and spray them from a nozzle. The carbon black used in the present invention is not particularly limited. It is possible to use any carbon black. The viscosity of the mixture at 25° C., before drying processed in this way is preferably 3000 mPa·s or less, more preferably 2000 mPa·s or less, particularly preferably 1000 mPa·s or less. Due to this, it is possible to effectively prevent clogging of feed pipes and poor drying.

In this way, according to the method of the second aspect of the present invention, since the drying of the wet master batch containing carbon black, which used to take an extremely long time, becomes instantaneous, it becomes possible to produce a natural rubber/carbon black master batch by an industrially sufficient processing capacity.

The mixture dried by the pulse combustion may further include, if necessary, a vulcanizing agent, a vulcanization accelerator, an antioxidant, a metal oxide, a fatty acid, a resin, an oil, or other rubber compounding agents generally added to rubber compositions. When dried by the method of the present invention, it is possible to greatly reduce the compounding step of compounding agents to the rubber which used to be performed by a Banbury mixer, kneader, etc. and possible to immediately feed compound to the later steps of extrusion and rolling.

In one mode of the second aspect of the present invention, it is possible to uniformly mix, into the natural rubber latex and/or carbon black slurry, 1 to 30 wt %, preferably 3 to 20 wt % of a surfactant, based upon the weight of carbon black, in terms of solid, in advance and dry the mixture to obtain the desired master batch. By the use of the surfactant, the stability of the mixture of NR latex and carbon black, which results in gelling by just mixing, is improved and preparation of a master batch achieving uniform dispersion becomes possible. Further, by drying by pulse combustion, it is possible to dry with little molecular cleavage or heat history and possible to obtain a master batch exhibiting extremely good physical properties. It is also possible to mix and dry together other rubber compounding agents. The addition of these compounding agents at later steps can be eliminated and a great improvement of the productivity can be achieved.

The surfactant (or emulsifier) capable of being used in the present invention is not particularly limited, but a nonionic surfactant, cationic surfactant, anionic surfactant, ampholytic surfactant, etc. may be used. In particular, nonionic surfactants and cationic surfactants are preferably used. As nonionic surfactants, for example, polyoxyethylene alkyl ethers, polyoxyalkylene alkyl ethers, sugar fatty acid esters, polyoxyethylene sorbitan fatty acid esters, polyoxyethylene sorbitol fatty acid esters, polyhydric alcohol fatty acid esters, polyoxyethylene fatty acid esters, polyoxyethylene alkyl amines, alkyl alkanol amides, etc. may be mentioned. As cationic surfactants, for example, alkyl sulfate ester salts, polyoxyethylene alkyl ether sulfate ester salts, alkyl sulfonates, alkyl benzene sulfonates, alkyl naphthalene sulfonates, naphthalate sulfonates, alkyl sulfosuccinates, alkyl diphenyl ether disulfonates, fatty acid salts, polyhydric carboxylates, alkyl sulfate triethanolamine, alkenyl succinates, alkyl phosphate ester salts, polyoxyalkylene phosphate ester salts, etc. may be mentioned.

According to another second aspect of the present invention, it is possible to add a water-soluble polymer into said natural rubber latex and/or carbon black slurry, in advance, before drying by pulse combustion and then uniformly mix them and dry the same so as to obtain the desired master batch. The amount of use of the water-soluble polymer is 1 to 30 wt %, based upon the weight of the carbon black, in terms of solid, more preferably 3 to 20 wt %. Due to this addition, the stability of a mixture of NR latex and carbon black, which gels with just mixing, is improved and preparation of a master batch achieving uniform dispersion becomes possible. Further, by drying by pulse combustion, drying with little molecular cleavage or heat history becomes possible and extremely good physical properties can be exhibited.

The water-soluble polymer used in the present invention is not particularly limited so long as it is water soluble. For example, corn starch or another starch, mannan or pectin or another natural polysaccharide, agar or alginic acid or another seaweed, various types of gums, dextran or pulleran or another microorganisum-derived polysaccharide, hide glue or gelatin or another protein, carboxymethyl cellulose or hydroxyethyl cellulose or another cellulose derivative, polyacrylic acid, polyacrylamide, polyvinyl alcohol, polyethylene imine, polyethylene oxide, polyvinyl pyrrolidone, or another synthetic polymer may be used. Particularly preferable water-soluble polymers are polyvinyl alcohol (PVA) or water-soluble cellulose derivatives or their salts. Among the polyvinyl alcohols, sulfonate-modified polyvinyl alcohol is further preferable and enables a mixture more superior in emulsion stability to be obtained. Further, among water-soluble cellulose derivatives, carboxymethyl cellulose (CMC) and its salts are particularly preferable. In particular, use of ones having an etherification degree of 0.5 to 1.6, more preferably 0.6 to 1.5, are more preferred. This is because in particular carboxymethyl cellulose (CMC) is more superior in emulsion stability compared with ordinary emulsifiers and enables a stable mixture, and further cellulose derivatives are very small in impact on the environment and high in safety.

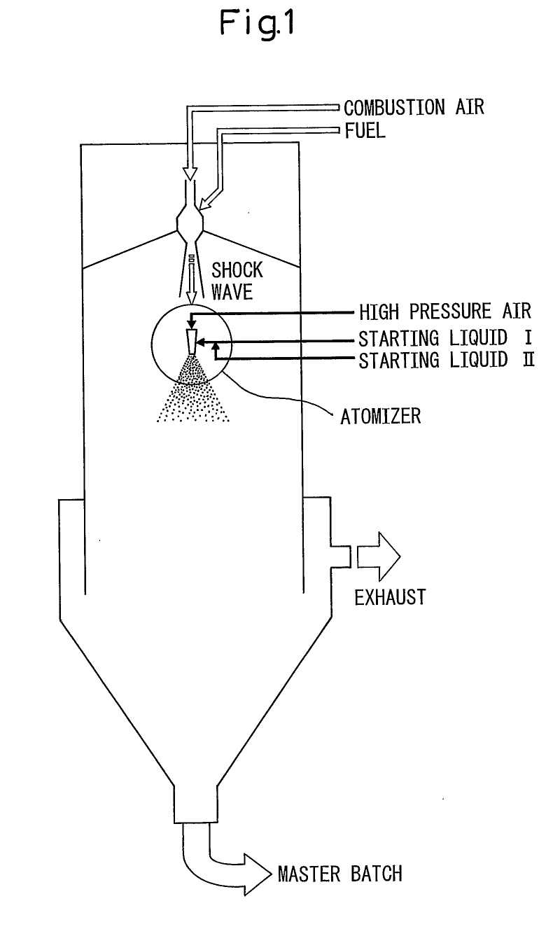

According to a further second aspect of the present invention, by using an apparatus for mixing and drying a solution or dispersion of at least two types of solid substances as shown in, for example, FIG. 1 provided with pumps for feeding at least two types of stock solutions, a control mechanism for controlling a feed ratio of the pumps, at least two stock solution feed paths for feeding at least two types of stock solutions at any ratio, and a pulse combuster for making said two stock solution feed paths converge to a single path, then spraying and drying the mixture in an atmosphere of a shock wave obtained by pulse combustion so as to introduce a natural rubber latex and carbon black slurry and, in some cases, dispersions of one or both of these to which a surfactant or water-soluble polymer is added from separate stock feed paths so as to dry the mixture by pulse combustion, the result becomes batch processing suitable for mass production like with the method of mixing, then drying the latex and carbon black slurry, but is not suitable for short run diverse production, while by separately and individually feeding the stocks and controlling the feed ratio, it is possible to freely set and dry a master batch or composition of any mixing ratio.

In particular, the method of the present invention is extremely effective for preparing a master batch of a mixture of an NR latex and carbon black which results in gelling several seconds to tens of seconds after mixing. By drying by pulse combustion, drying with little molecular cleavage or heat history is possible. Note that a surfactant, PVA, or a water-soluble cellulose derivative or other emulsifier may also be added to either, depending upon the need.

According to the second aspect of the present invention, when mixing and drying a natural rubber latex and aqueous slurry of carbon black to produce a master batch, it is possible to separately supply a natural rubber latex and carbon black slurry from at least two starting material feed lines, combine them into a single line, then spray and dry the mixture in an atmosphere of a shock wave generated from pulse combustion to produce a master batch. The time after combining the starting material feed lines to a single line to when spraying the mixture into the atmosphere of a shock wave generated from pulse combustion is preferably 0.1 to 10 seconds, more preferably 1 to 5 seconds. If the time is too long, the mixture is liable to coagulate inside the nozzle before being sprayed, and therefore this is not preferred.

The viscosity at 25° C. of the mixture of the starting latex and carbon black slurry (measured by a type B viscometer) is preferably 3000 mP·s or less, more preferably 2000 mPa·s or less, particularly preferably 1000 mPa·s or less.

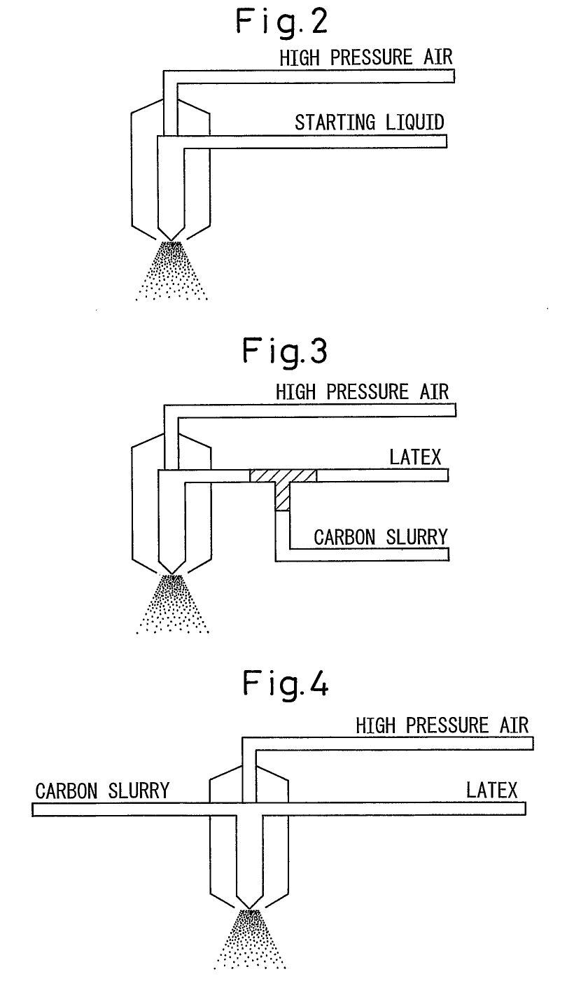

Further, the frequency of the pulse combustion is preferably 50 to 1200 Hz, whereas the temperature of the drying chamber for spraying the latex is preferably 140° C. or less, more preferably 40 to 100° C. According to the present invention, as shown in FIG. 1, a desirable effect is obtained by providing a control mechanism for automatically controlling the feed ratio of the pumps feeding the starting liquids I and II, providing at least two starting material feed lines for feeding at least two types of starting material at any ratio, combining them to a single line, then spraying and drying the mixture in an atmosphere of a shock wave generated from pulse combustion. FIG. 2 shows the structure of a conventional sprayer, while FIG. 3 and FIG. 4 show the structures of preferable aspects of sprayers according to the present invention.

### EXAMPLES

The present invention will now be explained in further detail by Examples, but the scope of the present invention is not limited to these Examples.

### Example 1 and Comparative Example 1

As Comparative Example 1, the method for producing a rubber composition from a mixture of 2 kg of natural rubber latex (made in Thailand, 30 wt % dry rubber content) and 1 kg of colloidal silica (made by Nissan Chemical Industries, Snowtex 30) by a conventional vacuum drying method is shown. The natural rubber latex is tapped, then foreign matter removed and colloidal silica mixed with the result and mixture. This mixture was coagulated by adding formic acid, followed by vacuum drying with agitation at 80° C. to remove the moisture. The resultant mixture is then roll mixed to obtain the desired rubber composition. The time required was 10 hours and 15 minutes as shown in Table I.

On the other hand, in Example 1, 2 kg of the same natural rubber latex as in Comparative Example 1 stabilized by addition of ammonia was filtered for impurities, then mixed with 1 kg of colloidal silica. The mixture was sprayed and dried using a pulse shock wave dryer (Hypulcon made by Pultech) under conditions of a frequency of 1000 Hz and a temperature of 60° C. The drying times of the latices of Example 1 and Comparative Example 1 were compared in Table I below. As is clear from the results of Table I, in Example 1 according to the present invention, the drying time for processing about 3 liters of latex was shortened to about 1.5 hours. Note that the drying time was the processing capacity of the pulse shock wave dryer. The time required for the moisture to be actually removed was not more than 1 second. Due to the size of the dryer, the amount of the latex capable of being dried per unit time is determined. The processing capability of the dryer used in Example 1 according to the present invention was about 2 kg/hour.

TABLE I
NR Latex/Colloidal Silica

| Comp. Ex. 1 (Prior Art) | | | Ex. 1 | | |
|---|---|---|---|---|---|
| | Required | | | Required | |
| Step | time | | Step | time | |
| Charging of NR latex/ | | | Charging of NR latex/ | | |
| colloidal silica | | | colloidal silica | | |
| Agitation | 5 | min | Agitation | 5 | min |
| Vacuum drying | 10 | hr | Drying by pulse | 1.5 | hr |
| (80° C.) | | | combustion | | |
| Roll mixing | 10 | min | Roll mixing | 10 | min |

(Note)
The NR latex and colloidal silica were first mixed with stirring. The remaining compounding agents (zinc oxide, stearic acid, sulfur, and vulcanization accelerator) were mixed by a roll.

### Example 2 and Comparative Example 2

The rubber physical properties of the natural rubber and silica master batch obtained in Example 1 and Comparative Example 1 were compared. That is, in the formulation shown in Table II, the ingredients other than the vulcanization accelerator and sulfur were compounded in a 1.7 liter Banbury mixer for 5 minutes. When reaching 140° C., the resultant mixture was discharged to obtain a master batch. The vulcanization accelerator and sulfur were compounded into the master batch by an 8-inch open roll (temperature adjusted to 40° C.) to obtain a rubber composition. The unvulcanized rubber composition obtained was vulcanized in a 15×15×0.2 cm mould at 150° C. for 30 minutes to obtain a vulcanized rubber sheet which was then measured for rubber physical properties by the test method shown below. The results are shown in Table II.

300% modulus (MPa): Measured according to JIS K-6251 (JIS No. 3 dumbbell)

Tensile strength at break: Measured according to JIS K-6251 (JIS No. 3 dumbbell)

Elongation at break: Measured according to JIS K-6251 (JIS No. 3 dumbbell)

tan δ (60° C.) : Measured using a Rheograph Solid made by Toyoseiki at an initial elongation of 10%, a dynamic strain of 2% and a frequency of 20 Hz (sample width 5 mm).

As is clear from the results shown in Table II, in Example 2 according to the present invention, due to the instantaneous drying of the latex, the dispersion of the silica was improved and the tensile properties and viscoelastic properties were improved.

TABLE II
Physical Properties of Compound of Silica Master Batch

| Name of material (Tradename) | Comp. 2 | Ex. 2 |
|---|---|---|
| Formulation (parts by weight) | | |
| Comp. Ex. 1 master batch | 150 | — |
| Ex. 1 master batch | — | 150 |
| (of which, amount of silica) | (50) | (50) |
| Zinc oxide, made by Seido Chemical Industry | 3 | 3 |
| (Zinc White #3) | | |
| Stearic acid, made by NOF (Beads Stearic Acid) | 2 | 2 |
| Sulfur, made by Tsurumi Chemical (“Kinka” | 1.5 | 1.5 |
| brand fine powder sulfur 150 mesh) | | |
| Vulcanization accelerator, made by Ouchi Shinko | 1 | 1 |
| Chemical (Noccelar NS-F) | | |
| Material physical properties (room temperature) | | |
| 300% modulus (MPa) | 9.2 | 8.8 |
| Tensile strength at break (MPa) | 21.7 | 26.4 |
| Elongation at break (%) | 520 | 600 |
| tan δ (60° C.) | 0.09 | 0.07 |

### Example 3 and Comparative Example 3

Except for replacing the colloidal silica with 300 g of clay (Kunipia F made by Kunimine Industry) (dispersed in 1800 kg of water) for 2 kg of NR latex, the same procedure was followed as in Comparative Example 1 and Example 1 to obtain a rubber composition. The required time was shortened to 2 hours as shown in Table II.

TABLE III
NR Latex/Clay

| Comp. Ex. 3 (Prior Art) | | | Ex. 3 | | |
|---|---|---|---|---|---|
| | Required | | | Required | |
| Step | time | | Step | time | |
| Charging of clay/ | | | Charging of clay/ | | |
| water mixture | | | water mixture | | |
| Mixing of aqueous | | | Mixing of aqueous | | |
| slurry/NR latex | | | slurry/NR latex | | |
| Agitation | 5 | min | Agitation | 5 | min |
| Vacuum drying | 10 | hr | Drying by pulse | 2 | hr |
| (80° C.) | | | combustion | | |
| Roll mixing | 10 | min | Roll mixing | 10 | min |

(Note)
The NR latex and clay were first mixed with stirring. The remaining compounding agents (zinc oxide, stearic acid, sulfur, and vulcanization accelerator) were mixed by a roll.

### Example 4 and Comparative Example 4

The rubber physical properties of the natural rubber and clay master batch obtained in Example 3 and Comparative Example 3 were compared in the same way as in Example 2 and Comparative Example 2 in the formulations shown in Table IV. That is, the ingredients other than the vulcanization accelerator and sulfur were compounded in a 1.7 liter internal mixer for 5 minutes. When reaching 140° C., the resultant mixture was discharged to obtain a master batch. The vulcanization accelerator and sulfur were compounded in this master batch by an 8-inch open roll to obtain a rubber composition.

Next, the rubber composition obtained was vulcanized in a 15×15×0.2 cm mould at 150° C. for 30 minutes to prepare a vulcanized rubber sheet which was then measured for 300% modulus, tensile strength at break and elongation at break by the above test methods. Further, the permeability was measured by the following method. The results are shown in Table IV. As is clear from the results of Table IV, according to the method of the present invention, the dispersion of the clay was improved and the tensile properties and permeability were improved compared with the conventional method.

Permeability: The rubber compositions obtained in Example 3 and Comparative Example 3 were vulcanized to diameters of 10 cm and thicknesses of 0.5 mm and measured for permeability of air at 60° C. using a gas permeability measurement apparatus MT-C3 made by Toyoseiki. The values were shown by indexes against the value of the rubber of Comparative Example 3 as 100. The smaller the value, the better (the more difficult the passage of air).

TABLE IV
Physical Properties of Compound of Silica Master Batch

| Name of material (Tradename) | Comp. 4 | Ex. 4 |
|---|---|---|
| Formulation (parts by weight) | | |
| Comp. Ex. 2 master batch | 150 | — |
| Ex. 2 master batch | — | 150 |
| (of which, amount of clay) Kunipia F (Kunimine | (50) | (50) |
| Industries) | | |
| Zinc oxide, made by Seido Chemical Industry | 3 | 3 |
| (Zinc White #3) | | |
| Stearic acid, made by NOF (Beads Stearic Acid) | 2 | 2 |
| Sulfur, made by Tsurumi Chemical (“Kinka” | 1.5 | 1.5 |
| brand fine powder sulfur 150 mesh) | | |
| Vulcanization accelerator, made by Ouchi Shinko | 1 | 1 |
| Chemical (Noccelar NS-F) | | |
| Material physical properties (room temperature) | | |
| 300% modulus (MPa) | 13.7 | 13.4 |
| Tensile strength at break (MPa) | 19.4 | 21.3 |
| Elongation at break (%) | 420 | 470 |
| tan δ (60° C.) (index) | 100 | 96 |

Permeability: Index against the value of Comparative Example 4 as 100. The smaller the value, the lower the air permeability shown.

### Examples 5 to 8 and Comparative Example 5

Samples were dried by pulse combustion and stabilization tests conducted according to the formulations shown in Table V. The drying by pulse combustion was conducted using a Hypulcon made by Pultech at a frequency of 1000 Hz and a temperature of 60° C., while adding and mixing a surfactant to the carbon black slurry. The results are shown in Table V. Note that in Comparative Example 5, the sample results in gelling immediately after mixing the natural rubber latex and carbon black slurry making the drying test impossible.

TABLE V

| | Comp. | | | | |
|---|---|---|---|---|---|
| | Ex. 5 | Ex. 5 | Ex. 6 | Ex. 7 | Ex. 8 |
| Formulation | | | | | |
| (parts by weight) | | | | | |
| NR latex (rubber | 166.67 | 166.67 | 166.67 | 166.67 | 166.67 |
| ingredient 60 wt %) | | | | | |
| (Hytex HA, Golden | | | | | |
| Hope Plantations) | | | | | |
| Carbon black | 50 | 50 | 50 | 50 | 50 |
| (Shoblack N339, | | | | | |
| Showa Cabot) | | | | | |
| Water | 500 | 500 | 500 | 500 | 500 |
| Cationic surfactant | — | 5 | — | — | — |
| (Taycapower LN2450, | | | | | |
| Taica) | | | | | |
| Nonionic surfactant | — | — | 5 | — | — |
| (Emulgen 1108, Kao) | | | | | |
| PVA (Gohsenol GM-14, | — | — | — | 5 | — |
| Nippon Synthetic | | | | | |
| Chemical Industry) | | | | | |
| Sulfonate-modified | — | — | — | — | 5 |
| PVA (Gohsenol L-3266, | | | | | |
| made by Nippon | | | | | |
| Synthetic) Chemical | | | | | |
| Industry | | | | | |
| Evaluated | | | | | |
| physical properties | | | | | |
| Stabilization test | | | | | |
| Right after | Gelling | ++ | ++ | ++ | ++ |
| preparation | | | | | |
| After 24 hours | − | + | + | ++ | ++ |
| Drying by pulse | Not OK | OK | OK | OK | OK |
| combustion | | | | | |

Stabilization test: The state right after preparation of master batch and the state after standing for 24 hours at room temperature observed and evaluated under the following criteria:
Uniform liquid state held and no increase in viscosity or gel observed
Some increase in viscosity, but liquid state held.

### Examples 9 to 12 and Comparative Example 6

Next, the carbon master batches of Examples 5 to 8 obtained above were used for evaluation of the rubber physical properties by the formulations shown in Table VI. That is, in each of the formulations shown in Table VI, the components other than the vulcanization accelerator and sulfur were compounded in a 1.7 liter Banbury mixer for 3 minutes (mixing for 5 minutes in Comparative Example 6) to obtain a master batch. The vulcanization accelerator and sulfur were compounded into the master batch by an 8-inch open roll to obtain a rubber composition. The unvulcanized rubber composition obtained above was vulcanized in a 15×15×0.2 cm mould at 150° C. for 30 minutes to obtain a vulcanized rubber sheet which was then measured for rubber physical properties by the test methods shown below. The results are shown in Table VI. Further, the weight average molecular weight was measured. The results are shown in Table VI.

300% modulus (MPa): Measured according to JIS K-6251 (JIS No. 3 dumbbell)

Tensile strength at break: Measured according to JIS K-6251 (JIS No. 3 dumbbell)

Elongation at break: Measured according to JIS K-6251 (JIS No. 3 dumbbell)

Weight average molecular weight (GPC method): The weight average molecular weights (Mw) of the solvent solubles of the carbon black master batches of the Examples and Comparative Examples were measured using GPC (Gel Permeation Chromatography).

TABLE VI

| | Ex. | Ex. | Ex. | Ex. | Comp. |
|---|---|---|---|---|---|
| | 9 | 10 | 11 | 12 | Ex. 6 |
| Formulation | | | | | |
| (parts by weight) | | | | | |
| NR master batch of | 155 | — | — | — | — |
| Example 5 | | | | | |
| NR master batch of | — | 155 | — | — | — |
| Example 6 | | | | | |
| NR master batch of | — | — | 155 | — | — |
| Example 7 | | | | | |
| NR master batch of | — | — | — | 155 | — |
| Example 8 | | | | | |
| NR (STR20) | — | — | — | — | 100 |
| HAF grade carbon | — | — | — | — | 50 |
| (Shoblack N339, | | | | | |
| Showa Cabot) | | | | | |
| Zinc oxide (Zinc | 5 | 5 | 5 | 5 | 5 |
| White #3, Seido | | | | | |
| Chemical Industry) | | | | | |
| Stearic acid (Beads | 3 | 3 | 3 | 3 | 3 |
| Stearic Acid, NOF) | | | | | |
| Antioxidant | 1 | 1 | 1 | 1 | 1 |
| (Nocrack 6C, Ouchi | | | | | |
| Shinko Chemical | | | | | |
| Industrial) | | | | | |
| Sulfur (“Kinka” | 1.5 | 1.5 | 1.5 | 1.5 | 1.5 |
| brand fine powder | | | | | |
| sulfur (150 mesh), | | | | | |
| Tsurumi Chemical) | | | | | |
| Vulcanization | 1 | 1 | 1 | 1 | 1 |
| accelerator | | | | | |
| (Noccelar NS-F, | | | | | |
| Ouchi Shinko | | | | | |
| Chemical Industrial) | | | | | |
| Evaluated | | | | | |
| physical properties | | | | | |
| 300% modulus (MPa) | 13.4 | 13.6 | 14.3 | 14.7 | 16.0 |
| Tensile strength at | 26.2 | 22.2 | 21.0 | 26.7 | 19.0 |
| break (MPa) | | | | | |
| Elongation at break | 500 | 450 | 420 | 480 | 340 |
| (%) | | | | | |
| GPC method weight | 4.92 | 4.70 | 4.77 | 4.63 | 3.21 |
| average molecular | | | | | |
| weight (Mw) ×10⁵ | | | | | |

### Examples 13 to 16 and Comparative Example 7

Water-soluble cellulose derivatives were added and mixed with carbon black slurry according to the formulations shown in Table VII using Hypulcon made by Pultech at a frequency of 1000 Hz and a temperature of 60° C. to prepare master batches. Stabilization tests of the master batches obtained were conducted under the following criteria. The results are shown in Table VII. Note that in Comparative Example 7, right after the natural rubber latex and carbon black slurry were mixed, the sample results in gelling, and therefore the drying test could not be conducted.

Stabilization test: The state right after preparation of prepared master batch and the state after standing for 24 hours at room temperature observed and evaluated under the following criteria:
Uniform liquid state held and no increase in viscosity or gel observed
Some increase in viscosity, but liquid state held.

Considerable increase in viscosity with fine gel observed, but sprayable

TABLE VII

| | Comp. | | | | |
|---|---|---|---|---|---|
| | Ex. 7 | Ex. 13 | Ex. 14 | Ex. 15 | Ex. 16 |
| Formulation | | | | | |
| (parts by weight) | | | | | |
| NR latex (rubber | 166.67 | 166.67 | 166.67 | 166.67 | 166.67 |
| ingredient 60 wt %) | | | | | |
| (Hytex HA, Golden | | | | | |
| Hope Plantations) | | | | | |
| Carbon black | 50 | 50 | 50 | 50 | 50 |
| (Shoblack N339, | | | | | |
| Showa Cabot) | | | | | |
| Water | 1000 | 1000 | 1000 | 1000 | 1000 |
| Carboxymethyl | — | 5 | — | — | — |
| cellulose, CMC | | | | | |
| Daicel 1105 | | | | | |
| (Daicel Chemical | | | | | |
| Industries)*¹ | | | | | |
| Carboxymethyl | — | — | 5 | — | — |
| cellulose, CMC | | | | | |
| Daicel 1310 | | | | | |
| (Daicel Chemical | | | | | |
| Industries)*² | | | | | |
| Carboxymethyl | — | — | — | 5 | — |
| cellulose, | | | | | |
| Anestogam 9450 | | | | | |
| (Daicel Chemical | | | | | |
| Industries)*³ | | | | | |
| Hydroxyethyl | — | — | — | — | 5 |
| cellulose, HEC | | | | | |
| Daicel SP200 | | | | | |
| (Daicel Chemical | | | | | |
| Industries)*⁴ | | | | | |
| Evaluated | | | | | |
| physical properties | | | | | |
| Stabilization test | | | | | |
| Right after | Gelling | ++ | ++ | + | + |
| preparation | | | | | |
| After 48 hours | − | + | + | ± | ± |
| Drying by pulse | Not OK | OK | OK | OK | OK |
| combustion | | | | | |

*¹Etherification degree 0.6
*²Etherification degree 1.2
*³Etherification degree 1.7
*⁴Etherification degree 0.5

### Examples 17 to 20 and Comparative Example 8

Next, the rubber physical properties were evaluated in the formulations shown in Table VIII using the carbon master batches of Examples 17 to 20 obtained above. That is, in each of the formulations shown in Table VIII, the ingredients other than the vulcanization accelerator and sulfur were compounded by a 1.7 liter Banbury mixer for 3 minutes (mixing for 5 minutes for Comparative Example 8) to obtain a master batch. The vulcanization accelerator and sulfur were compounded into the master batch by an 8-inch open roll to obtain a rubber composition. The obtained unvulcanized rubber composition was vulcanized in a 15×15×0.2 cm mould at 150° C. for 30 minutes to obtain a vulcanized rubber sheet which was then measured for rubber physical properties by the test methods shown below. The results are shown in Table VIII.

300% modulus (MPa): Measured according to JIS K-6251 (JIS No. 3 dumbbell)

Tensile strength at break: Measured according to JIS K-6251 (JIS No. 3 dumbbell)

Elongation at break: Measured according to JIS K-6251 (JIS No. 3 dumbbell)

TABLE VIII

| | Ex. | Ex. | Ex. | Ex. | Comp. |
|---|---|---|---|---|---|
| | 17 | 18 | 19 | 20 | Ex. 8 |
| Formulation (parts by weight) | | | | | |
| NR master batch of Example 13 | 155 | — | — | — | — |
| NR master batch of Example 14 | — | 155 | — | — | — |
| NR master batch of Example 15 | — | — | 155 | — | — |
| NR master batch of Example 16 | — | — | — | 155 | — |
| NR (STR20) | — | — | — | — | 100 |
| HAF grade carbon (Shoblack | — | — | — | — | 50 |
| N339, Showa Cabot) | | | | | |
| Zinc oxide (Zinc White #3, | 5 | 5 | 5 | 5 | 5 |
| Seido Chemical Industry) | | | | | |
| Stearic acid (Beads Stearic | 3 | 3 | 3 | 3 | 3 |
| Acid, NOF) | | | | | |
| Antioxidant (Nocrack 6C, Ouchi | 1 | 1 | 1 | 1 | 1 |
| Shinko Chemical Industrial) | | | | | |
| Sulfur (“Kinka” brand | 1.5 | 1.5 | 1.5 | 1.5 | 1.5 |
| fine sulfur (150 mesh), | | | | | |
| Tsurumi Chemical) | | | | | |
| Vulcanization accelerator | 1 | 1 | 1 | 1 | 1 |
| (Noccelar NS-F, Ouchi Shinko | | | | | |
| ChemicalIndustrial) | | | | | |
| Evaluated physical properties | | | | | |
| 300% modulus (MPa) | 15.1 | 15.8 | 14.8 | 14.5 | 16.0 |
| Tensile strength at break | 26.0 | 26.4 | 23.0 | 22.5 | 19.0 |
| (MPa) | | | | | |
| Elongation at break (%) | 490 | 510 | 460 | 440 | 350 |

### INDUSTRIAL APPLICABILITY

As explained above, according to the method for producing a polymer composition according to the present invention, it is possible to greatly simplify the production of a polymer composition from a latex containing a natural rubber or synthetic rubber or other general polymer or other latex, which used to require a long time. Further, the mixing time and energy of the rubber by a Banbury mixer etc. can be reduced. This is useful as a new method of mixing rubber. According to the method for producing a master batch from a natural rubber latex and carbon black slurry according to the present invention, since the mixture is sprayed under an atmosphere of a shock wave generated from pulse combustion and the solvent is removed to instantaneously dry the natural rubber latex and carbon black slurry, the work efficiency and heat efficiency of production of a natural rubber/carbon black master batch can be improved, there is little liability of heat degradation or gelling as in the past in the quality of the master batch obtained as well, the production of a master batch can be greatly simplified, and the mixing time and the energy of rubber by a Banbury mixer can be reduced, and therefore the method is useful as a new method for producing a master batch.

1. A method for producing a polymer composition containing a filler comprising simultaneously spraying and drying a liquid containing a polymer component and a liquid containing a filler under an atmosphere of a shock wave generated from pulse combustion.

2. A method for producing a polymer composition as claimed in claim 1, further comprising mixing the filler or filler-containing liquid with the liquid containing said polymer component, before spraying, and then spraying it under an atmosphere of a shock wave generated from pulse combustion.

3. A method for producing a polymer composition as claimed in claim 1, wherein the filler is at least one filler selected from the group consisting of carbon black, silica, water-glass, colloidal silica, clay and calcium carbonate.

4. A method for producing a polymer composition as claimed in claim 1, wherein the liquid containing a polymer component is a liquid containing a rubber latex.

5. A method for producing a polymer composition as claimed in claim 1, wherein the polymer composition mixture before drying has a viscosity at 25° C. of 3000 mPa·s or less.

6. A method for producing a polymer composition as claimed in claim 1, wherein a frequency of the pulse combustion is 50 to 1200 Hz and a temperature of a drying chamber of the atmosphere of the shock wave generated from pulse combustion for spraying the liquid containing a polymer composition is 140° C. or less.

7. A polymer composition produced by the method according to claim 1.

8. A method for producing a natural rubber/carbon black master batch comprising mixing, into a natural rubber latex, an aqueous slurry of carbon black containing 1 to 200 parts by weight of carbon black, based upon 100 parts by weight, in terms of a solid, of the rubber and 1 to 30 wt % of a surfactant based upon the weight of the carbon black (solid content), then spraying and drying the mixture thus obtained under an atmosphere of a shock wave generated from pulse combustion.

9. A method for producing a master batch as claimed in claim 8, wherein the surfactant is mixed, in advance with at least one of natural rubber latex and aqueous slurry of carbon black, followed by agitating and mixing the natural rubber latex and the carbon black slurry.

10. A method for producing a master batch as claimed in claim 8, wherein the surfactant is a nonionic surfactant or cationic surfactant.

11. A method as claimed in claim 10, wherein a viscosity at 25° C. of the mixture before drying is 3000 mPa·s or less.

12. A method for producing a master batch as claimed in claim 8, wherein a frequency of the pulse combustion is 50 to 1200 Hz and a temperature of a drying chamber under the atmosphere of the shock wave generated from pulse combustion for spraying the latex is 140° C. or less.

13. A method for producing a master batch as claimed in claim 8, wherein the mixture further contains at least one compounding agent selected from the group consisting of vulcanizing agents, vulcanization accelerators, antioxidants, metal oxides, fatty acids, resins and oils.

14. A master batch produced by a method according to claim 8.

15. A method for producing a natural rubber/carbon black master batch comprising mixing, into a natural rubber latex, an aqueous slurry of carbon black and a water-soluble polymer, then spraying and drying the mixture thus obtained under an atmosphere of a shock wave generated from pulse combustion.

16. A method for producing a master batch as claimed in claim 15, further comprising mixing, into at least one natural rubber latex and the aqueous slurry of carbon black, the water-soluble polymer, and then agitating and mixing the latex and carbon black slurry.

17. A method for producing a master batch as claimed in claim 15, wherein the water-soluble polymer is polyvinyl alcohol (PVA), a water-soluble cellulose derivative or a salt thereof.

18. A method for producing a master batch as claimed in claim 17, wherein an etherification degree of the water-soluble cellulose derivative is 0.5 to 1.6.

19. A method for producing a master batch as claimed in claim 17, wherein a viscosity at 25° C. of the mixture is 3000 mP·s or less.

20. A method for producing a master batch as claimed in claim 15, wherein a frequency of the pulse combustion is 50 to 1200 Hz and a temperature of a drying chamber for spraying the latex is 140° C. or less.

21. A method for producing a master batch as claimed in claim 15, wherein the mixture further contain at least one compounding agent selected from the group consisting of vulcanizing agents, vulcanization accelerators, antioxidants, metal oxides, fatty acids, resins and oils.

22. A master batch produced by a method according to claim 15.

23. A method for producing a natural rubber/carbon black master batch by mixing a natural rubber latex and an aqueous slurry of carbon black, followed by drying, comprising separately feeding the natural rubber latex and the carbon black slurry from at least two starting material feed lines, which is combined into a single line, and then spraying and drying the mixture under an atmosphere of a shock wave generated from pulse combustion.

24. A method for producing a master batch as claimed in claim 23, wherein a time after combining the starting material feed lines to a single line, then spraying the mixture under an atmosphere of a shock wave generated from pulse combustion is 0.1 to 10 seconds.

25. A method for producing a master batch as claimed in claim 23, wherein viscosities at 25° C. of the natural rubber latex and the aqueous slurry of carbon black are 3000 mP·s or less, respectively.

26. A method for producing a master batch as claimed in claim 23, wherein a frequency of the pulse combustion is 50 to 1200 Hz and a temperature of a drying chamber for spraying the latex is 140° C. or less.

27. A master batch produced by a method according to claim 23.

28. An apparatus for mixing and drying at least two starting liquid or dispersion of solid substances, comprising pumps for feeding at least two starting liquids, a control mechanism for controlling a feed ratio of the pumps, at least two starting liquid feed lines for feeding at least two starting liquids at any ratio, and a pulse combustion apparatus for spraying, after combining the at least two starting liquid feed lines into the single feed line, the combined liquids and drying the mixture under an atmosphere of a shock wave generated from pulse combustion.

29. A drying apparatus as claimed in claim 28, wherein said at least two starting liquids are a natural rubber latex and an aqueous slurry of carbon black.
